(19) United States
(12) Patent Application Publication
(10) Pub. No.: US 2025/0129834 A1
(43) Pub. Date: Apr. 24, 2025

(54) BUILT-IN ELECTROMAGNETIC VALVE FOR SHOCK ABSORBER

(71) Applicant: BorgWarner Automotive Components (Tianjin) Co., Ltd., Tianjin (CN)

(72) Inventors: Shen Zhouzhou, Tianjin (CN); Yuan Zhengzheng, Tianjin (CN); Li Jian, Tianjin (CN); Yao Yanqing, Tianjin (CN); Zhou Jin, Tianjin (CN); Zhao Li, Tianjin (CN); Liu Xianfeng, Tianjin (CN)

(21) Appl. No.: 18/987,444

(22) Filed: Dec. 19, 2024

(30) Foreign Application Priority Data
Oct. 23, 2023 (CN) CN202311372540.8

(51) Int. Cl. F16F 9/34; F16F 9/32

(52) U.S. Cl. CPC F16F 9/34; F16F 9/3278

(57) ABSTRACT

An internal damping valve for shock absorbers, comprising a main valve member, a valve housing, a valve sleeve and a main valve seat, the valve sleeve is connected with the valve housing, the main valve member is arranged in the valve sleeve, and the main valve seat is arranged at an end of the main valve member; the main valve member comprises a first channel, a second channel and a third channel; The third channel runs through the main spool, allowing fluid to enter the third channel from both directions. The fluid then passes through the third channel into a second oil flow path, subsequently flowing to the feedback chamber of the main spool. This reduces the eccentricity of the main spool caused by radial fluid entering unidirectionally, helping to maintain the relative balance of the main spool and improving the responsiveness and operational stability of the damping valve.

### CROSS REFERENCE TO RELATED APPLICATIONS

This application claims the priority to Chinese Patent Application No. CN202311372540.8 filed on Oct. 23, 2023, and the entire content of this priority application is incorporated herein by reference in its entirety.

### TECHNICAL FIELD

The application relates to the technical field of vehicle suspension damping devices, which may be an internal damping valve for shock absorbers.

### BACKGROUND

Shock absorbers are an important component of vehicle suspension systems, designed to suppress oscillations caused by the rebound of shock-absorbing springs and impacts from the road. It acts to dampen vibrations between a chassis and a vehicle body, improving the smoothness of the vehicle's ride and its handling stability. The shock absorber comprises a damping valve, which controls the flow of hydraulic fluid within a chamber of the shock absorber, facilitating the adjustment of damping properties of the shock absorber to provide effective shock absorption for the vehicle. In the prior art, the damping valve regulates the pressure in a pilot valve chamber by adjusting the input current, thereby controlling the opening of a main spool to adjust the damping level of the shock absorber.

In the prior art, reference can be made to Chinese patent CN219317506U, which provides a damping valve with adjustable damping for shock absorbers. A bottom of an installation chamber is provided with a pilot valve that connects a valve chamber to an oil outlet gap. The pilot valve comprises an upper main valve seat, a lower main valve seat, and a valve ball, and a pilot chamber is formed between the upper main valve seat and the lower main valve seat. Pilot valve holes that connect the valve chamber to the pilot chamber and the pilot chamber to the oil outlet gap are respectively formed in the middle of the upper main valve seat and the middle of the lower main valve seat. Additionally, a small oil outlet is formed in the upper main valve seat, and a pilot reset spring is arranged on the lower main valve seat, ensuring that the valve ball always tends to move upward to seal the upper main valve seat. An upper end of a valve housing is provided with a push rod and an electromagnetic drive component that drives the push rod to move up and down. When the electromagnetic drive component is powered, the push rod can move downward, allowing the valve ball to overcome the elastic force of the pilot reset spring and the hydraulic pressure to move downward. During compression, a small portion of oil in an oil inlet channel enters the pilot valve through a first check valve, and flows through a fourth check valve into an oil outlet channel, and under the action of the pilot valve, a main spool opens, allowing most of the oil to enter the oil outlet channel through a gap between the main spool and the installation chamber. During recovery, a small portion of oil in the oil outlet channel enters the pilot valve through a second check valve, and flows through a third check valve back to a liquid inlet channel, and under the action of the pilot valve, the main spool opens, allowing most of the oil to flow back to the oil outlet channel through the gap between the main spool and the installation chamber.

As shown in the accompanying illustration, for a damping valve in the prior art, fluid from the radial exterior enters the main spool 3 through the oil outlet channel 8 and then flows into the main valve chamber 4 via the second check valve 7. However, the opening and closing direction of the second check valve 7 is oriented radially, requiring the fluid to overcome the elastic force of a spring at the second check valve 7 in order to compress the spring and open the passage at the second check valve 7. On one hand, the radial fluid force acting on the main spool 3 can create uneven stress, leading to eccentricity under the fluid pressure, which affects the dynamic balance of the main spool 3 and its sensitivity. On the other hand, the instability of the fluid when opening the second check valve 7 can impact the stability of fluid flow into the main spool 3, thus affecting the operational stability of the main spool.

Therefore, there is room for further improvement in the damping valve for shock absorbers in the prior art.

### SUMMARY

To address the technical issue in the aforementioned damping valve, where the structure of the main spool experiences uneven stress due to the radial fluid, leading to eccentricity that affects dynamic stability and results in poor operational stability of the damping valve, this application provides an internal damping valve for shock absorbers. By reasonably designing the structure of the main spool, the main spool can maintain better dynamic balance, thereby ensuring stable operation and improved performance of the damping valve.

This application provides an internal damping valve for shock absorbers, comprising a main valve member, a valve housing, a valve sleeve and a main valve seat, wherein the valve sleeve is connected with the valve housing, the main valve member is arranged in the valve sleeve, and the main valve seat is arranged at an end of the main valve member;
the main valve member comprises a main spool, and the main spool is provided with a feedback chamber, a first channel, a second channel and a third channel;
the feedback chamber is arranged on one end face of the main spool;
one end of the first channel is connected with the feedback chamber, and the other end is provided with an opening on the other end face of the main spool;
two ends of the third channel are provided with openings on a side wall of the main spool; and
one end of the second channel is connected with the feedback chamber, and the other end is connected with the third channel.

Compared to the prior art, the internal damping valve for shock absorbers proposed in this application features the first channel and the second channel on the main spool to direct fluid from outside the valve core to the feedback chamber. One end of the second channel is connected with the third channel, and the two ends of the third channel are provided with openings on the side wall of the main spool, allowing it to pass through the main spool. Fluid can enter from the openings on two opposing sides of the third channel, allowing for bidirectional entry into the third channel, which then directs the fluid into a second oil flow path. This fluid then flows to the feedback chamber of the main spool, ensuring that the force exerted by the fluid on the main spool is not unidirectional. This reduces the eccentricity caused by unidirectional radial fluid flow on the main spool, allowing the main spool to maintain relative balance. As a result, when the main spool displaces axially, the wear rate between the main spool and the valve sleeve is minimized, enhancing the responsiveness and operational stability of the damping valve.

The main spool may be provided with a fourth channel, one end of the fourth channel is connected with the second channel, and the other end is connected with the third channel; an inner diameter of the fourth channel is smaller than that of the third channel;
the main spool is provided with a fifth channel, one end of the fifth channel is connected with the first channel, and the other end is connected with the feedback chamber; and an inner diameter of the fifth channel is smaller than that of the first channel.

The third channel may be divided into a middle channel and side channels, the side channels are arranged at two ends of the middle channel, and the side channels are connected with the middle channel;
the middle channel is connected with the second channel; and
a diameter of the middle channel is smaller than that of the side channel.

The main valve member may also comprise check valve components, and the first channel and the second channel are both provided with check valve components; and
the check valve component corresponding to the second channel comprises a second limiting part and a second check valve ball, and the second limiting part is connected with the main spool for limiting the second check valve ball in the second channel.

An end, away from the second limiting part, of the second channel may be provided with a second limiting valve port, and a diameter of the second limiting valve port is smaller than that of the second check valve ball.

The second limiting part may be provided with a second oil outlet valve port and oil outlet grooves, and the oil outlet grooves are evenly distributed along a circumference of the second oil outlet valve port;
an inner diameter of the second oil outlet valve port is smaller than a diameter of the second check valve ball; and
a distance between a bottom of the oil outlet groove and a central axis of the second oil outlet valve port is greater than a radius of the second check valve ball.

The check valve component corresponding to the first channel may comprise a first limiting part and a first check valve ball; and
the first limiting part is connected with the main spool for limiting the first check valve ball in the first channel.

The first limiting part may be provided with a first oil inlet valve port, and a diameter of the first oil inlet valve port is smaller than that of the first check valve ball.

The other end, away from the first limiting part, of the first channel may be provided with a first limiting valve port and flow path grooves, and the flow path grooves are evenly distributed along a circumference of the first limiting valve port;
an inner diameter of the first limiting valve port is smaller than a diameter of the first check valve ball; and
a distance between a bottom of the flow path grooves and a central axis of the first oil outlet valve port is greater than a radius of the first check valve ball.

A valve chamber may be arranged in the damping valve, and the valve chamber is connected with the feedback chamber;
the valve sleeve is provided with a first oil flow path and a second oil flow path;
one end of the first oil flow path is connected with the valve chamber, and the other end is provided with an opening on an end face of the valve sleeve; and
one end of the second oil flow path is connected with the valve chamber, and the other end is provided with openings on an inner wall and a side wall of the valve sleeve.

The internal damping valve for shock absorbers provided by this application at least has the following technical effects.

1. By orienting the opening and closing directions of the first channel and the second channel axially, when fluid from the side of the main spool flows through the third channel and the second channel towards the end face where the feedback chamber is located, the guidance from the third channel and the second channel can convert radial forces into axial forces. The gravitational force along the axial direction of the second check valve ball aligns with the direction of the fluid force, ensuring uniform stress on the second check valve ball, reducing the influence of other factors, and enhancing the stability and sensitivity of the second check valve.

2. The third channel is designed to run through the main spool in the radial direction, enabling fluid to flow into the main spool from both ends of the third channel when oil is introduced. This allows the main spool to maintain good dynamic balance under the influence of radial fluid forces, thereby enhancing the responsiveness of the main spool.

3. By positioning the axis of the second channel on the axial centerline of the oil passage and symmetrically arranging the third channel along the axis of the second channel, the dynamic balance of the main spool can be enhanced.

### BRIEF DESCRIPTION OF THE DRAWINGS

FIG. 1 is a structural diagram of an internal damping valve for shock absorbers;

FIG. 2 is a first sectional view of an internal damping valve for shock absorbers in the axial direction;

FIG. 3 is a second sectional view of an internal damping valve for shock absorbers in the axial direction;

FIG. 4 is a perspective view of a main spool;

FIG. 5 is a first perspective sectional view of a main spool in the axial direction;

FIG. 6 is a second perspective sectional view of a main spool in the axial direction;

FIG. 7 is a partially enlarged view of part A in FIG. 2;

FIG. 8 is a partially enlarged view of part B in FIG. 3;

FIG. 9 is a perspective view of a second limiting part;

FIG. 10 is a top view of a second limiting part;

FIG. 11 is a perspective view of a first limiting part;

FIG. 12 is a sectional view of a first limiting part in the axial direction;

FIG. 13 is a partial sectional view of FIG. 2 taken along section line A-A; and

FIG. 14 is a sectional view of a damping valve with adjustable damping for shock absorbers in the prior art.

### DETAILED DESCRIPTION

This application will be further described below with reference to the accompanying drawings FIGS. 1-14.

This application provides an internal damping valve for shock absorbers, used in vehicle suspension damping devices, which adjusts the fluid flow to achieve damping regulation for the damping devices.

As shown in FIGS. 1-3, the internal damping valve for shock absorbers 1 comprises a main valve member 2, a valve housing 5, a valve sleeve 3, and a main valve seat 4. A lower end of the valve housing 5 is connected with the valve sleeve 3, and the valve sleeve 3 contains an installation chamber for installing a main spool 7. The main spool 7 is positioned within the installation chamber, and a valve chamber 6 capable of containing fluid is formed by an upper end of the main spool 7, a bottom of the valve housing 5 and a side wall of the valve sleeve 3. The main valve seat 4 is located in the installation chamber at an axial bottom of the main spool 7 and is fixedly connected to the valve sleeve 3, serving to restrict the downward axial movement of the main spool 7.

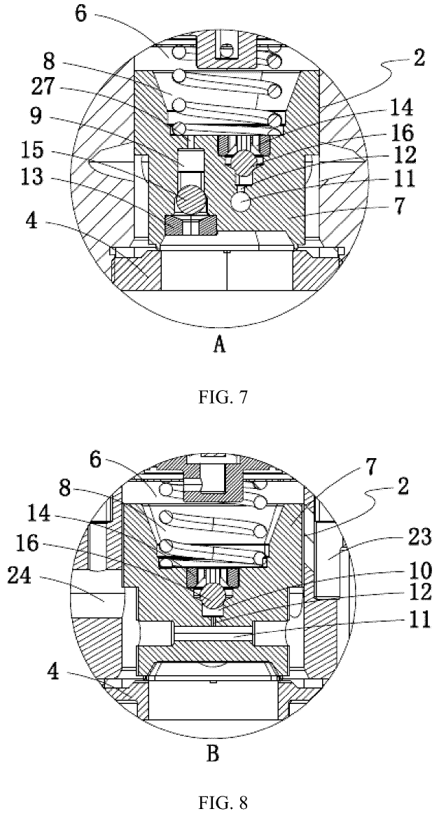

As shown in FIGS. 7 and 8, the main valve member 2 comprises the main spool 7, which has a feedback chamber 8 located on an axial upper end face. The feedback chamber 8 is recessed toward the center of the main spool 7 and is connected with the valve chamber 6. A first channel 9 is arranged axially, with one end connected with the feedback chamber 8 and the other end featuring an opening on the other end face of the main spool 7 away from a fluid outlet. Thus, fluid in the axial direction outside the main spool 7 can flow into the feedback chamber 8 via the first channel 9.

Two opposite ends of a third channel 11 have openings on a side wall of the main spool 7, which serve as oil inlets for the third channel 11, allowing fluid to enter the main spool 7 through these openings. One end of a second channel 10 is connected with the third channel 11, while the other end is connected with the feedback chamber 8. This configuration enables fluid to flow from the third channel 11 into the second channel 10 and subsequently into the feedback chamber 8, allowing external fluid to enter the damping valve 1 through the main spool 7. The third channel 11 runs through the main spool 7, permitting fluid to enter from openings on two opposing sides of the third channel 11. This bidirectional flow into the third channel 11 ensures that the force exerted on the main spool 7 is not unidirectional. This reduces the eccentricity caused by unidirectional forces on the main spool 7 during unidirectional fluid inflow, allowing the main spool 7 to maintain relative balance. As a result, when the main spool 7 displaces axially in the valve sleeve 3, the wear rate between the main spool 7 and the valve sleeve 3 is minimized, enhancing the responsiveness of the main spool 7.

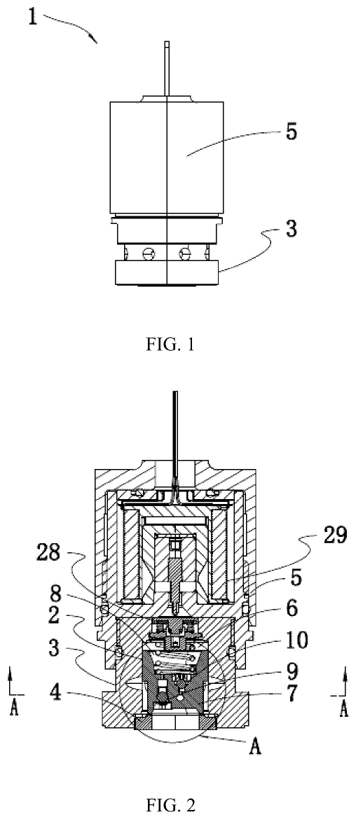

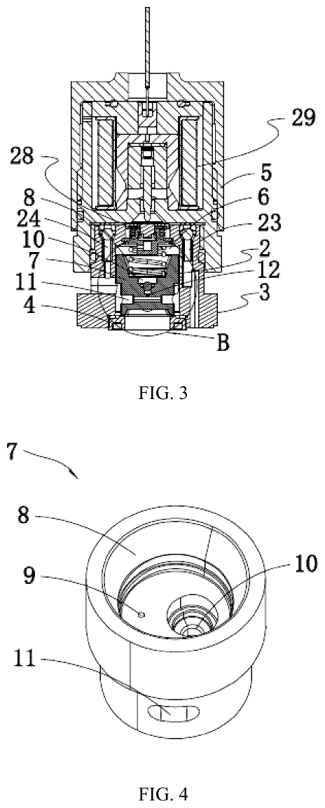

As shown in FIGS. 2 and 3, the feedback chamber 8 of the main spool 7 is located at an upper end of the main spool 7. The feedback chamber 8 of the main spool 7, together with the valve housing 5 and the valve sleeve 3, forms the valve chamber 6, allowing fluid to flow therein. The valve sleeve 3 is provided with a first oil flow path 23 and a second oil flow path 24, with one end of the first oil flow path 23 connected with the valve chamber 6 and the other end connected with the axial exterior of the damping valve 1. This arrangement enables the fluid in the valve chamber 6 to flow out of the damping valve 1 through the first oil flow path 23. One end of the second oil flow path 24 is connected with the valve chamber 6, while the other end has openings on an inner wall and side wall of the valve sleeve 3, establishing communication between the inside and outside of the valve sleeve 3. This allows fluid from the radial exterior of the damping valve 1 to enter the second oil flow path 24 and subsequently flow into the second channel 10, from which it can flow to the valve chamber 6 before flowing out of the damping valve 1 through the first oil flow path 23. Consequently, the damping valve 1 can control the fluid velocity and flow rate therein, assisting in adjusting the damping of a vehicle suspension damping device. On the other hand, fluid within the valve chamber 6 can also flow out to the exterior of the damping valve 1 via the second oil flow path 24.

Further, as shown in FIG. 3, both the first oil flow path 23 and the second oil flow path 24 are provided with check valve components. Each check valve ball moves upward, disconnecting the first oil flow path 23 or the second oil flow path 24 from the main valve chamber 6.

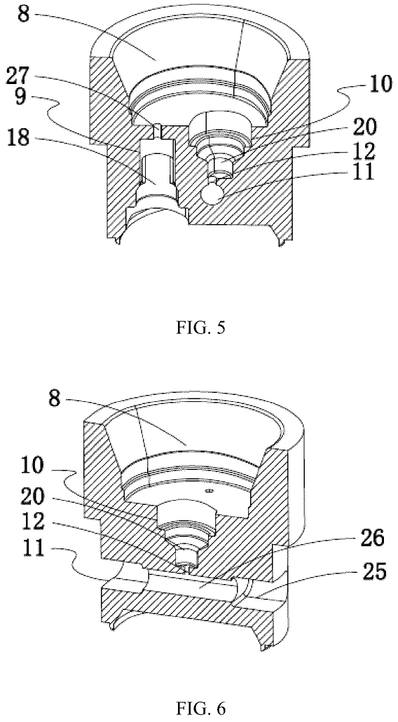

Additionally, as illustrated in FIGS. 5 and 6, the main spool 7 is also provided with a fourth channel 12, which is arranged axially. One end of the fourth channel 12 is connected with the second channel 10, while the other end is connected with the third channel 11. After flowing into the third channel 11, fluid moves through the fourth channel 12 into the second channel 10.

The inner diameter of the fourth channel 12 is smaller than that of the third channel 11. Due to the reduced diameter of the fourth channel 12, as fluid flows from the third channel 11 into the fourth channel 12, the decrease in the diameter of the flow path increases the velocity and kinetic energy of the fluid. This allows the fluid to gain sufficient kinetic energy to flow rapidly and smoothly from the radial direction to the axial direction into the second channel 10. This results in a significant force that pushes the second check valve ball 16, allowing the second channel 10 to be connected with the fourth channel 12 for fluid passage.

Further, the main spool 7 is provided with a fifth channel 27, which is arranged axially. One end of the fifth channel 27 is connected with the first channel 9, while the other end is connected with the feedback chamber 8. The inner diameter of the fifth channel 27 is smaller than that of the first channel 9. Due to the reduced diameter of the fifth channel 27, as fluid flows from the first channel 9 into the fifth channel 27, the decrease in the diameter of the flow path increases the velocity and kinetic energy of the fluid, enabling the fluid to gain sufficient kinetic energy to flow quickly and smoothly into the feedback chamber 8.

In another optional embodiment of this application, further expansion of the third channel 11 is implemented. In this embodiment, as shown in FIGS. 5 and 6, the axis of the third channel 11 is perpendicular to the axis of the second channel 10, meaning the second channel 10 is arranged axially while the third channel 11 is arranged radially. When radial fluid enters the third channel 11 through the second oil flow path 24, the fluid exerts a radial force and flows in the radial direction, thereby smoothly moving from the second oil flow path 24 to the third channel 11. This reduces the blocking effect on the fluid, allowing the radial fluid to quickly enter the damping valve 1, enhancing the responsiveness and sensitivity of the main spool 7.

The third channel 11 is symmetrically aligned along the axis of the second channel 10, allowing the fluid to maintain as much force balance as possible at two ends of the third channel 11 when flowing into the second channel 10 through an oil inlet channel. This further ensures the dynamic balance of the main spool 7, thereby improving the responsiveness and sensitivity of the main spool 7.

Further, as shown in FIGS. 6 and 8, the third channel 11 is divided into a middle channel 26 and side channels 25. The side channels 25 are positioned at two ends of the middle channel 26 and are connected to it. The axes of the side channels 25 and the middle channel 26 lie on the same straight line. The middle channel 26 is connected with the second channel 10, and a bottom of the second channel 10 is connected with a top of the middle channel 26. The diameter of the middle channel 26 is smaller than that of the side channels 25, which reduces the flow space available for the fluid when entering the middle channel 26 from the side channels 25. Due to the force of the fluid, the flow velocity in the middle channel 26 increases, resulting in greater kinetic energy as the fluid flows into the second channel 10, facilitating easier entry into the main spool 7 and thereby improving the operational efficiency of the damping valve 1.

In another optional embodiment of this application, further expansion is made based on any of the aforementioned embodiments. In this embodiment, as shown in FIGS. 7 and 8, the main valve member 2 also comprises check valve components. Both the first channel 9 and the second channel 10 are provided with check valve components that can open and close the communication between the first channel 9 and the second channel 10, thereby allowing the first channel 9 and the second channel 10 to have unidirectional flow characteristics.

The opening and closing direction of the first channel 9 is oriented axially, aligning with the flow direction of the fluid from the axial exterior of the main spool 7. This configuration ensures that the force direction of the fluid flowing into the main spool 7 through the first channel 9 in the axial direction is consistent, free from interference from other directions, thus enhancing the functional stability and sensitivity of the first channel 9.

The second channel 10 is arranged in the axial direction, while the third channel 11 is arranged in the radial direction. The fluid from the radial exterior of the main spool 7 can flow into the third channel 11, then through the second channel 10 for direction change, flowing axially along the second channel 10, and finally exiting from the feedback chamber 8. By placing a check valve component in the second channel 10, the opening and closing direction of the second channel by the check valve component is set axially. With the coordination of the second channel 10 and the third channel 11, lateral fluid enters the main spool 7 through the third channel 11, and then changes flow direction through the second channel 10. This configuration ensures that the force direction acting on the check valve component in the second channel 10 by the fluid matches the configuration direction of the second channel 10, unifying the opening and closing force direction on the check valve component in the second channel 10 and reducing the influence of forces from other directions on the check valve component, thereby improving the stability and sensitivity of the opening and closing of the second channel 10.

Further, as shown in FIGS. 2-3 and FIGS. 7-8, the check valve component corresponding to the second channel 10 comprises a second limiting block and a second check valve ball 16. The second check valve ball 16 is arranged within the second channel 10, and the second limiting part 14 is connected with the main spool 7. The second limiting part 14 is positioned at an end, near the feedback chamber 8, of the second channel 10, with its outer wall fitting against an inner wall of the second channel 10. The second limiting part 14 is used to limit the second check valve ball 16 within the second channel 10. The second limiting block is connected with the main spool 7 for limiting the second check valve ball 16 in the second channel 10.

Correspondingly, an end, away from the second limiting part 14, of the second channel is provided with a second limiting valve port 20. In the axial direction of the second channel 10, the second limiting part 14 is positioned at the upper end, while the second limiting valve port is located at the lower end. The second check valve ball 16 is situated between the second limiting part 14 and the second limiting valve port 20. The second limiting part 14 and the second limiting valve port 20 work together to restrict the axial movement of the second check valve ball 16, ensuring that the second check valve ball 16 remains within the second channel 10.

Further, the second limiting valve port 20 is cylindrical, with an end connected with the fourth channel 12. The diameter of the second limiting valve port 20 is smaller than that of the second check valve ball 16, allowing the second check valve ball 16 to only partially fit within the second limiting valve port 20, thereby blocking the second limiting valve port 20 and closing the second channel 10. When the second check valve ball 16 is in contact with the second limiting valve port 20, the second channel 10 is in a closed state and fluid cannot pass through. When the second check valve ball 16 is in contact with the second limiting part 14, the second channel 10 is in a connected state, allowing fluid to flow through the second channel 10.

Further, an upper side wall of the second limiting valve port 20 is designed with a conical structure. This allows the second check valve ball 16 to tend to slide downward when it is positioned at the conical structure, providing guidance for the downward movement of the second check valve ball 16 and ensuring that the second check valve ball 16 accurately falls into the second limiting valve port 20, thereby effectively closing the second channel 10.

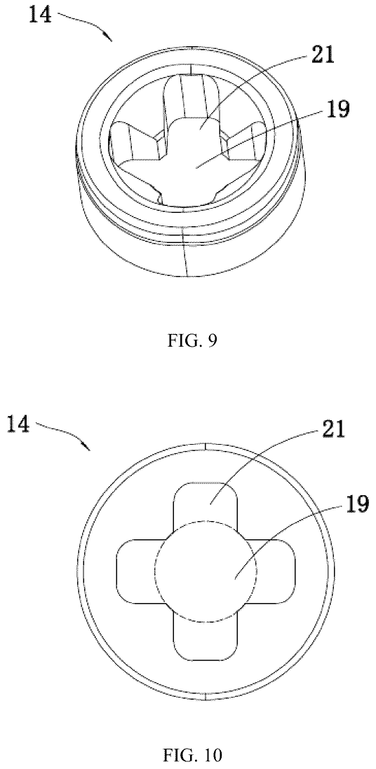

Further, as shown in FIGS. 9 and 10, the second limiting part 14 is provided with a second oil outlet valve port 19 and oil outlet grooves 21. The second oil outlet valve port 19 runs through the second limiting part 14, with one end connected with the feedback chamber 8 and the other end connected with the second channel 10. The inner diameter of the second oil outlet valve port 19 is smaller than the diameter of the second check valve ball 16, allowing a portion of the second check valve ball 16 to fit within the second oil outlet valve port 19, thus restricting the movement of the second check valve ball 16.

As shown in FIG. 10, the oil outlet grooves 21 are evenly distributed along a circumference of the second oil outlet valve port 19. The oil outlet groove 21 is recessed in the direction away from the center of the second limiting part 14. There is at least one oil outlet groove 21, which is connected with the second oil outlet valve port 19. The distance from a bottom of the oil outlet groove 21 to a central axis of the second oil outlet valve port 19 is greater than the radius of the second check valve ball 16, allowing fluid to bypass the second check valve ball 16 and flow out from the oil outlet groove 21 into the feedback chamber 8, ensuring smooth fluid flow when the second channel 10 is open.

Further, as shown in FIGS. 7-9, the second limiting part 14 is provided with an inclined surface facing the feedback chamber 8 at an end near the second check valve ball 16. This inclined surface forms a second conical recess at an end, in contact with the second check valve ball 16, of the second limiting part 14, allowing the second check valve ball 16 to better fit into the second conical recess. This increases the contact area between the second check valve ball 16 and the second limiting part 14. When fluid pushes the second check valve ball 16 axially upward, the second check valve ball 16 can move into the second conical recess, providing more stable contact with the second limiting part 14. This allows the second check valve ball 16 to be securely positioned within the second conical recess, resulting in more stable fluid flow. Additionally, the second conical recess has a guiding function that directs the second check valve ball 16 into the second conical recess, while ensuring that the center of the second check valve ball 16 is aligned with the center of the second conical recess.

Further, an inner wall of the second conical recess is a smooth curved surface, allowing for a better fit with the second check valve ball 16, which increases both the contact area and contact stability between the second check valve ball 16 and the second conical recess.

In another optional embodiment of this application, further expansion is made based on any of the aforementioned embodiments.

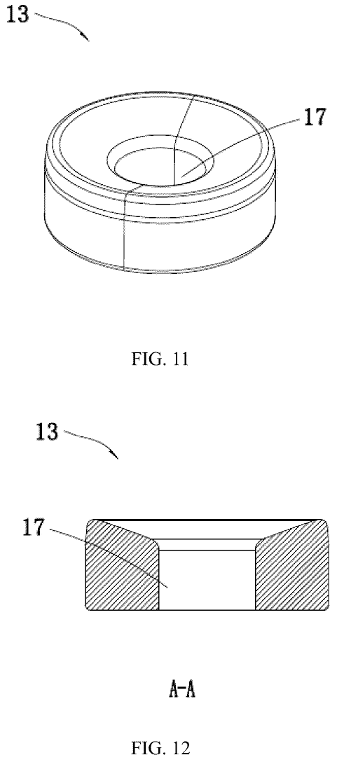

In this embodiment, as shown in FIGS. 7 and 8, the check valve component corresponding to the first channel 9 comprises a first limiting part 13 and a first check valve ball 15, both of which are positioned within the first channel 9. The first limiting part 13 is connected with the main spool 7 and is located at an end, away from the feedback chamber 8, of the first channel 9. An outer wall of the first limiting part 13 fits against an inner wall of the first channel 9, and the first limiting part 13 serves to restrict the first check valve ball 15 within the first channel 9. As illustrated in FIGS. 11 and 12, the first limiting part 13 is provided with a first oil inlet valve port 17, which is a cylindrical passage. One end of the first oil inlet valve port 17 is connected with the exterior of the main spool 7, while the other end is connected with the first channel 9. The diameter of the first oil inlet valve port 17 is smaller than that of the first check valve ball 15, allowing a portion of the first check valve ball 15 to fit within the first oil inlet valve port 17, thereby blocking the first oil inlet valve port 17 and closing the first channel 9.

Correspondingly, as shown in FIG. 5, the other end, away from the first limiting part 13, of the first channel 9 is provided with a first limiting valve port 18. In the axial direction of the first channel 9, the first limiting valve port 18 is located at the upper end, while the first limiting part 13 is at the lower end. The first limiting valve port 18 is cylindrical, with one end connected with the feedback chamber 8. The inner diameter of the first limiting valve port 18 is smaller than the diameter of the first check valve ball 15, allowing part of the first check valve ball 15 to enter the first limiting valve port 18, but preventing it from passing completely through. This arrangement allows the first limiting valve port 18 to limit the upward axial movement of the first check valve ball 15. The first check valve ball 15 is positioned between the first limiting part 13 and the first limiting valve port 18, and the first limiting part 13 and the first limiting valve port 18 work together to restrict the axial movement of the first check valve ball 15, ensuring that the first check valve ball 15 remains within the first channel 9.

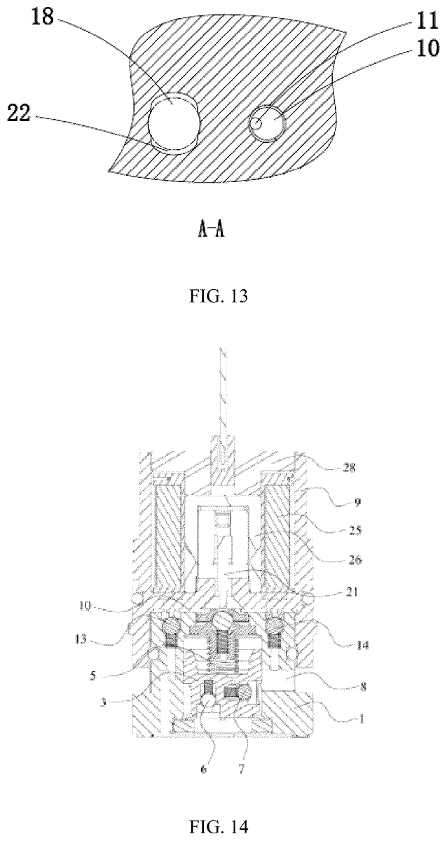

Further, as shown in FIG. 13, an inner wall of the first channel 9 is also provided with flow path grooves 22. The at least one flow path grooves 22 is evenly distributed along a circumference of the first limiting valve port 18. The flow path grooves 22 is recessed in the direction away from the axis of the first channel 9. The length from a bottom of the flow path grooves 22 to the axis of the first channel 9 is greater than the radius of the first limiting valve port 18, so that when the first check valve ball 15 is in complete contact with the bottom of the first limiting valve port 18, a gap is formed between the flow path grooves 22 and the first check valve ball 15, allowing fluid to flow through.

When the first check valve ball 15 is in contact with the first limiting valve port 18, the first channel 9 is in a connected state, allowing fluid outside of the main spool 7 to enter the first channel 9. When the first check valve ball 15 fits against the first limiting valve port 18 of a first limit ring, the first channel 9 is closed, and fluid outside of the main spool 7 cannot enter the first channel 9.

Further, as shown in FIG. 5, a lower side wall of the first limiting valve port 18 is designed with a conical structure, which guides the movement of the first check valve ball 15 when it lands on the conical structure. This ensures that the center of the first check valve ball 15 and the center of the first channel 9 are on the same axis, facilitating smooth contact between the first check valve ball 15 and the first limiting valve port 18, thereby enhancing the stability of fluid flow through the flow path grooves 22 and ensuring stability when the first channel 9 is open.

Further, as shown in FIGS. 7, 11, and 12, the first limiting part 13 features an inclined concave surface at an end near the second check valve ball 16, which directs away from the feedback chamber 8. This inclined concave surface allows the first limiting part 13 to form a first conical recess, increasing the contact area between the first check valve ball 15 and the first limiting part 13. This design enables the first check valve ball 15 to be guided into the first conical recess, ensuring that the first check valve ball 15 can stably block the inner circular first oil outlet valve port of the first limiting part 13, thereby closing the first channel 9.

Further, an inner wall of the first conical recess is a smooth curved surface, allowing for a better fit with the first check valve ball 15, which increases both the contact area and contact stability between the first check valve ball 15 and the first conical recess.

It should be noted that, as shown in FIGS. 2-3, the damping valve 1 of this application may also comprise a pilot valve module 28 and a driving component 29. The driving component 29 is located within the valve housing 5, and a lower end of the valve housing 5 is connected with the valve sleeve 3. The main spool 7 and the pilot valve module 28 are arranged in the valve sleeve 3, with the pilot valve module 28 at the axial upper end of the main spool 7. The pilot valve module 28 and a side wall of the valve sleeve 3 form a pilot chamber, which is connected with both the first oil flow path 23 and the second oil flow path 24. An upper end of the main spool 7, a bottom of the pilot valve module 28, and the valve sleeve 3 together form the valve chamber 6. The feedback chamber 8 of the main spool 7 is connected with the valve chamber 6, and the pilot chamber is also connected with the valve chamber 6. The driving component 29 can actuate the pilot valve module 28 to change the flow rate within the pilot chamber, thereby adjusting the opening between the main spool 7 and the main valve seat 4, which allows the damping valve 1 to regulate the flow rate of fluid between the two chambers in the shock absorber, enabling the adjustment of damping of the shock absorber.

Fluid flows from the first channel 9 or the second channel 10 of the main spool 7 into the valve chamber 6, then from the valve chamber 6 into the pilot chamber, and subsequently from the pilot chamber into the first oil flow path 23 or the second oil flow path 24, thus exiting the damping valve 1.

The working principle of the damping valve 1 in practical use is as follows:
when fluid flows in from the axial direction, as shown in FIGS. 2 and 7, it impacts the first check valve ball 15 in the first channel 9, pushing the first check valve ball 15 to open the first channel 9, allowing fluid to enter the first channel 9; the first check valve ball 15 is pushed to the first limiting valve port 18, and the fluid flows through the flow path grooves 22 into the feedback chamber 8, entering the valve chamber 6; as shown in FIG. 3, due to the axial fluid force, a lower end of the first oil flow path 23 of the damping valve 1 experiences pressure, causing the first oil flow path 23 to remain closed, and the fluid in the valve chamber 6 flows out through the second oil flow path 24 to the radial exterior of the damping valve 1;
when the fluid in the valve chamber 6 cannot exit through the second oil flow path 24, as the fluid flow rate and pressure increase, an upward force acts on the main spool 7, causing it to move upward in the axial direction; this results in the main spool 7 separating from the main valve seat 4, creating a large gap; the axial fluid then flows through the gap between the main valve seat 4 and the main spool 7 into the space between the valve sleeve 3 and the main spool 7, and subsequently exits through the second oil flow path 24;
when fluid flows in from the radial direction, as shown in FIGS. 2-3 and 7-8, it enters the gap between the main spool 7 and the valve sleeve 3 after passing through the second oil flow path 24; the fluid gradually accumulates and flows into the third channel 11 through the openings at both ends; when the third channel 11 is filled, the fluid flows upward, pushing a valve ball in the check valve, which connects the first oil flow path 23 to the third channel 11, allowing fluid to flow from the first oil flow path 23 into the valve chamber 6; as shown in FIG. 3, the external fluid acting radially on the main spool 7 exerts a force on the second oil flow path 24, resulting in an upward force at the lower end of the second oil flow path 24, keeping it closed; consequently, the fluid in the valve chamber 6 flows out through the first oil flow path 23 to the axial exterior of the damping valve 1; and
when the fluid in the valve chamber 6 cannot exit through the first oil flow path 23, as the fluid flow rate and pressure increase, an upward force acts on the main spool 7, causing it to move upward in the axial direction; this results in the main spool 7 separating from the main valve seat 24, creating a large gap; and once the fluid enters the space between the main spool 7 and the valve sleeve 3 from the second oil flow path 24, it flows out through the gap between the main valve seat 4 and the main spool 7.

What is claimed is:

1. An internal damping valve for shock absorbers, comprising a main valve member, a valve housing, a valve sleeve and a main valve seat, wherein the valve sleeve is connected with the valve housing, the main valve member is arranged in the valve sleeve, and the main valve seat is arranged at an end of the main valve member;
the main valve member comprises a main spool, and the main spool is provided with a feedback chamber, a first channel, a second channel and a third channel;
the feedback chamber is arranged on one end face of the main spool;
one end of the first channel is connected with the feedback chamber, and the other end is provided with an opening on the other end face of the main spool;
two ends of the third channel are provided with openings on a side wall of the main spool; and
one end of the second channel is connected with the feedback chamber, and the other end is connected with the third channel.

2. The internal damping valve for shock absorbers according to claim 1, wherein
the main spool is provided with a fourth channel, one end of the fourth channel is connected with the second channel, and the other end is connected with the third channel; an inner diameter of the fourth channel is smaller than that of the third channel;
the main spool is provided with a fifth channel, one end of the fifth channel is connected with the first channel, and the other end is connected with the feedback chamber; and an inner diameter of the fifth channel is smaller than that of the first channel.

3. The internal damping valve for shock absorbers according to claim 1, wherein
the third channel is divided into a middle channel and side channels, the side channels are arranged at two ends of the middle channel, and the side channels are connected with the middle channel;
the middle channel is connected with the second channel; and
a diameter of the middle channel is smaller than that of the side channel.

4. The internal damping valve for shock absorbers according claim 1, wherein
the main valve member also comprises check valve components, and the first channel and the second channel are both provided with check valve components; and
the check valve component corresponding to the second channel comprises a second limiting part and a second check valve ball, and the second limiting part is connected with the main spool to limit the second check valve ball in the second channel.

5. The internal damping valve for shock absorbers according to claim 4, wherein
an end, away from the second limiting part, of the second channel is provided with a second limiting valve port, and a diameter of the second limiting valve port is smaller than that of the second check valve ball.

6. The internal damping valve for shock absorbers according to claim 4, wherein
the second limiting part is provided with a second oil outlet valve port and oil outlet grooves, and the oil outlet grooves are evenly distributed along a circumference of the second oil outlet valve port;
an inner diameter of the second oil outlet valve port is smaller than a diameter of the second check valve ball; and
a distance between a bottom of the oil outlet groove and a central axis of the second oil outlet valve port is greater than a radius of the second check valve ball.

7. The internal damping valve for shock absorbers according to claim 4, wherein
the check valve component corresponding to the first channel comprises a first limiting part and a first check valve ball; and
the first limiting part is connected with the main spool for limiting the first check valve ball in the first channel.

8. The internal damping valve for shock absorbers according to claim 7, wherein
the first limiting part is provided with a first oil inlet valve port, and a diameter of the first oil inlet valve port is smaller than that of the first check valve ball.

9. The internal damping valve for shock absorbers according to claim 7, wherein
the other end, away from the first limiting part, of the first channel is provided with a first limiting valve port and flow path grooves, and the flow path grooves are evenly distributed along a circumference of the first limiting valve port;
an inner diameter of the first limiting valve port is smaller than a diameter of the first check valve ball; and
a distance between a bottom of the flow path grooves and a central axis of the first oil outlet valve port is greater than a radius of the first check valve ball.

10. The internal damping valve for shock absorbers according to claim 1, wherein a valve chamber is arranged in the damping valve, and the valve chamber is connected with the feedback chamber;
the valve sleeve is provided with a first oil flow path and a second oil flow path;
one end of the first oil flow path is connected with the valve chamber, and the other end is provided with an opening on an end face of the valve sleeve; and
one end of the second oil flow path is connected with the valve chamber, and the other end is provided with openings on an inner wall and a side wall of the valve sleeve.
